(19) United States
(12) Patent Application Publication
(10) Pub. No.: US 2014/0262616 A1
(43) Pub. Date: Sep. 18, 2014

(54) Ladder and Equipment Leash system and method

(71) Applicant: Nathaniel Ray Cullum, Midland, TX (US)

(72) Inventor: Nathaniel Ray Cullum, Midland, TX (US)

(21) Appl. No.: 13/827,420

(22) Filed: Mar. 14, 2013

(51) Int. Cl. E06C 7/18; B65H 75/34

(52) U.S. Cl. CPC E06C 7/188; B65H 75/34
USPC 182/107; 242/384.7; 242/371; 242/382

(57) ABSTRACT

A system for retaining a leash or other equipment or implement to a structure, such as a building, includes a clamp, a spool connected to the clamp, a leash wrapped on the spool, the leash has a first end connected to the spool and a second end extendable from the spool, a spring connected to the spool, the spring biases the spool to retrieve the leash when extended from the spool, and a leash clutch connected to the clamp. The leash clutch is engaged to brake the leash to limit extension and retraction of the leash on the spool. The leash is attachable to a fixture of the structure to maintain the ladder or other equipment or implement positioned in respect to the structure.

### TECHNICAL FIELD

The present invention generally relates to retention systems for other devices, and more particularly relates to retractable leashes which may positionally retain devices, for example, ladders or other equipment or devices, from falling or dislodging during use.

### BACKGROUND

Ladders and other movable implements are often used in construction, maintenance, repair and the like. When work is to be performed at a raised location, such as atop a roof of a house or building or up a tree or other fixture, ladders and other climbing or lifting systems allow access for workmen and supporting equipment that must be positioned at the raised location. As work progresses at the raised location, various equipment, such as buckets, nailers, sweepers, and other implements, may be required.

Ladders, as well as other devices and equipment, can shift, dislodge or fall from placement for use. A ladder, as one nonexclusive example, can shift and potentially fall because of wind, vibration of fixtures, inadvertent jostling by workers, or otherwise. If the ladder shifts or falls, a raised worker can be stranded on a roof, tree or other raised location. Moreover, falling or shifting of the ladder can cause person and property injury or damage.

A ladder, or other device or equipment, that shifts or falls from placement causes inconvenience. With a ladder, a worker in raised location must be aided by another, by replacement of the ladder in usable position. As with ladders, other equipment at the raised location can shift, tumble, or fall, causing inconvenience. For example, equipment used atop a roof or in a tree can tumble, resulting in delay and inconvenience in recovering the equipment.

Fixed brackets, bands, clamps, hooks and similar securement devices have been employed to retain ladders and other equipment in relative fixed position to a structure. These fixed securement devices, although possibly helpful for stability and security, are impractical and inconvenient. The ladder or equipment must be disengaged from the securement device, in order to transport and move the ladder or equipment to a different location.

It therefore would be desirable to provide systems and methods for engagingly retain ladders, equipment and other devices from shifting or falling in use. It would also be desirable to provide convenience of ready disengagement from engaging structures, when desired for movement and transport of the devices.

### SUMMARY

Embodiments of the invention include systems and methods for retaining a ladder, equipment, or implement to a structure, such as a building, tree, or other structure, by a leash.

An embodiment of the invention includes a system. The system includes a spool, a leash wrapping the spool, a first end of the leash is connected to the spool and a second end of the leash is unwrappingly extendable from the spool, a bias device connected to the spool for biasing the spool to wrappingly retrieve the leash when extended, a housing connected to and containing the spool, the housing includes a portal, the second end of the leash exiting the housing through the portal, and a clamp connected to the housing.

Another embodiment of the invention includes a system for retaining a ladder to a structure. The system includes a clamp, a spool connected to the clamp, a leash wrapping the spool, the leash has a first end connected to the spool and a second end extendable from the spool, a spring connected to the spool for biasing the spool to retrieve the leash when extended from the spool, and a lease clutch connected to the clamp, for limiting extension and retraction of the leash on the spool.

Yet another embodiment of the invention includes a system for retaining a ladder to a structure. The system includes a leash, having a first end and a second end, a biased spool containing the leash, the first end of the leash connected to the biased spool and the second end of the leash extendable from the biased spool by pulling the second end sufficient to overcome biasing of the biased spool, and a clamp connected to the biased spool, the clamp removably attachable to the ladder.

Another embodiment of the invention includes a method of retaining a ladder to a structure. The method includes attaching a retractable leash to the ladder and selectively clutching the retractable leash to prevent the retractable leash from retracting and extending.

### BRIEF DESCRIPTION OF THE DRAWINGS

The present invention is illustrated by way of example and not limitation in the accompanying figures, in which like references indicate similar elements, and in which:

FIG. 1 illustrates a front perspective view of a leash system, according to certain embodiments of the invention;

FIG. 2 illustrates a right side (in comparison to FIG. 1) perspective view of a leash system, in partial view of the housing taken along line A-A′ of FIG. 1 to illustrate a spool of the system, according to certain embodiments of the invention;

FIG. 3 illustrates a right side (in comparison to FIG. 1) perspective view of a leash system, in particle view of the housing taken along line A-A′ of FIG. 1 and missing a clutch and spool cover (in comparison to FIG. 2) to illustrate a spring of the system, according to certain embodiments of the invention;

FIG. 4 illustrates a right side (in comparison to FIG. 1) view of a leash system, in partial view of the housing taken along line A-A′ of FIG. 1 to illustrate a disengaged clutch of the system, according to certain embodiments of the invention;

FIG. 5 illustrates a right side (in comparison to FIG. 1) view of a leash system, in partial view of the housing taken along line A-A′ of FIG. 1 to illustrate an engaged clutch of the system, according to certain embodiments of the invention;

FIG. 6A illustrates a front (in comparison to FIG. 1) view of a leash system and clamp of the system for retaining a ladder, to illustrate screw vising action of the clamp, according to certain embodiments of the invention;

FIG. 6B illustrates a front (in comparison to FIG. 1) view of a leash system and clamp of the system for retaining a ladder, to illustrate toggle clamping action of the clamp, according to certain embodiments of the invention;

FIG. 7 illustrates a perspective view of an example of a leash system in use with a ladder, for example, a clamp of the leash system is attached to a side rail of the ladder, according to certain embodiments of the invention;

FIG. 8 illustrates a perspective view of another example of a leash system in use with a ladder, for example, a bracket and clamp of the leash system is switched in relation to a housing of the system when attached to another side rail of the ladder, according to certain embodiments of the invention;

FIG. 9 illustrates a right side (in comparison to FIG. 1) view of a leash system in use with a ladder, to illustrate angular relationship of extension direction of a leash to a bracket of the system, according to certain embodiments of the invention;

FIGS. 10A-C illustrate respective front side (in comparison to FIG. 1) views of a leash system attached by a clamp to different ladders, respectively, according to certain embodiments of the invention;

FIG. 11 illustrates a front and right side view of an alternative leash system having a toggle clamp opposing a leash exit portal, according to certain embodiments of the invention; and

FIG. 12 illustrates a sequence of partial front side (in comparison to FIG. 11) views of the alternative leash system with toggle clamp of FIG. 11 in clamping operation for attachment to a ladder, according to certain embodiments of the invention.

### DETAILED DESCRIPTION

Referring to FIG. 1, a system 100 for retaining a ladder or implement (not shown in FIG. 1) to a structure (not shown in FIG. 1) includes a housing 102 having a portal 104. A length of a leash 106 is connected to and contained in the housing 102. An end 106a of the leash 106 passes from within the housing 102, through the portal 104, to outside of the housing 102. A leash lock button 108 connects to a leash lock mechanism (not shown in FIG. 1) contained by the housing 102. The housing 102 connects to, or is otherwise incorporated or formed, with a clamp 110. The leash 106 is biased to recoil or otherwise return extended portions of the leash 106 to the housing 102.

In operation, the system 100 is removably fixed by the clamp 110 to the ladder or implement, for example, to a side rail of the ladder. The leash lock button 108 is positioned to unlock the leash 106. The end 106a of the leash 106 passing from the portal 104 is pulled by force sufficient to counter the recall bias, further extending portions of the leash 106 from within housing 102. The end 106a of the leash 106 is tied or otherwise attached (for example, by hook, loop, buckle, or other) to the structure. The leash lock button 108 is positionally moved to lock the leash 106. The locked leash 106 retains the ladder in relative position to the structure, preventing the ladder from shifting or falling.

Further in operation, the leash lock button 108 can, at desired time for moving or shifting the ladder or implement, be movably positioned to unlock the leash 106, allowing the recoil bias to retain the leash 106 taught but extendable on sufficient pull force. The leash 106 is then untied or detached from the structure. The leash 106 recoils into the housing 102. The ladder or implement can then be shifted or moved as desired, free from restraint by the leash 106. When the ladder or implement is next positioned for use, the leash 106 is again employed to retain the ladder or implement and the process of operation of the leash 106 is repeated.

Referring to FIG. 2, in conjunction with FIG. 1, a partial system 200 includes a spool 202 contained within a half-portion of the housing 102 (taken along line A-A′ of FIG. 1). The spool 202 rotatingly rides on a spindle 204 connected internally to the housing 102. The spool 202 therearound wrappingly accommodates the leash 106, allowing the leash 106 to wrap the spool 202 when the leash 106 is retracted in the portal 104 and to unwrap from the spool 202 when the leash 106 is extended through the portal 104. An opposing end of the leash 106 (i.e., opposite to end 106a) may be tied or otherwise attached or secured to the spool 202.

A cover 206 of the spool 202 encloses a bias device 308 (shown in FIG. 3, hereafter) for biasing the spool 202 to recoil the leash 106. The cover 206 may serve as a template to maintain the spool 202 centered on the spindle 204. The cover 206 forms or otherwise is connected to a fastener 208 for attaching the cover to the spindle 204.

The housing 102 is formed with a slot 210 (shown, in half-part, in FIG. 2), to allow a protrusion 212 formed by or otherwise connected to the leash lock button 108 to slide within the slot 210. For example, a portion of the housing 102 (shown in FIG. 2) forming a half-portion of the slot 210 connects to another portion of the housing 102 (shown connected in FIG. 1, but not shown in FIG. 2) having a corresponding half-portion of the slot 210, to form the slot 210. The leash lock button 108 forms or is otherwise connected to the protrusion 212 that fits and rides within the slot 210. The protrusion 212 passes from the leash lock button 108 external to the housing 102, through the slot 210, to internal to the housing 102.

Within the housing 102, the protrusion 212 forms or is otherwise connected to a clutch 214. The clutch 214, when engaged by selectively positioning the leash lock button 108 along the slot 210, restricts the leash 106 from further outwardly extending from the housing 102 or recoiling on the spool 202. When the clutch 214 is not engaged by so positioning the leash lock button 108, the leash 106 recoils on the spool 202 because of recall bias or, if pulled with sufficient force (e.g., manual pull) to overcome the recall bias of the bias device 308, can be pullingly extended from the spool 202. The clutch 214 includes a first end 214a lockingly engageable with the leash 106 when the leash lock button 108 is pushed along the slot 210 towards the portal 104. A second end 214b of the clutch 214 moves into internal contact with housing 102 when the leash lock button is so positioned.

The housing 102 is also formed with an internal rib 211 beyond an extent of the slot 210 opposing the portal 104. The rib 211 is selectively located to lodge the second end 214b of the clutch 214 to positionally retain the leash lock button 108 when pushed along the slot 210 to lockingly engage with the leash 106. The rib 211 is selectively sized to permit the leash lock button 108 to be pushed along the slot 210 away from the portal 104, in order to release the leash 106 from locked engagement. In certain non-exclusive embodiments, the protrusion 212 is sized to allow the leash lock button 108 to be depressed slightly towards the spool 202 in order to dislodge the second end 214b from engagement with the rib 211 prior to pushing the leach lock button 108 along the slot away from the portal 104.

Internal to the housing 102, the housing 102 can also form or otherwise connect to other elements operative for locking the leash 106, for example, clutch guides 220 (shown in further detail in FIGS. 4 and 5, hereafter). The clutch guides 220 maintain the clutch 214 positionally displaced in relation to the spool 202, allowing movement of the leash lock button 108 along the slot 210. Various other internal elements of the housing 102 can provide structural strength for the clutch 214 and leash lock button 108, for example, the housing 102 may internally include a lower post 216 and an upper post 218 opposing the slot 210, and/or others.

Referring to FIG. 3, in conjunction with FIGS. 1 and 2, a spool system 300 includes the spool 202 with the cover 206 removed (in comparison to FIG. 2), contained within the half-portion of the housing 102 of FIG. 2 (with the leash lock button 108, clutch 214, and related elements removed for purpose of explanation). The spool 202 is of a circumferential width 202a sufficient to accommodate the leash 106 on the spool 202 in sequential laps around the circumference. The leash 106 preferably wraps the spool 202 in adjacent laps along the circumferential width 202a, when wrapping the circumference of the spool 202. The leash 106 may, but need not necessarily, wrap the spool 202 in more than one layer of such adjacently lapping lengths, in order to provide added extensibility of leash 106. The spindle 204 and spool 202, in combination, may but need not necessarily provide camming action to wind and unwind the leash 106 from the spool 202 in an organized manner. The spool 202 forms opposing perimeter guides 302 along the bounds of the circumferential width 202a of the spool 202. The guides 302 maintain the leash 106 wrapped within the circumferential width 202a of the spool 202.

The spool 202 forms, in whole or part, a hollow cylindrical chamber 304 capable of accommodating a bias device 308. The chamber 304 is cylindrically internally lined by bushings 306. The bias device 308 is connected within the chamber 304, to the spindle 204 and to the spool 202. A non-exclusive example of the bias device 308 is a concentrically wound spring connected at one end to the spindle 204 and at another end to an inner cylindrical surface of the spool 202. For example, the spindle 204 includes a notch 204a for retaining an end of the spring and the spool 202 includes an attachment device 202b accessible via the chamber 304 for retaining another end of the spring.

In an exemplary embodiment of the spring as the bias device 308, the spring is wound within the chamber 304 to provide sufficient recoil bias to the spool 202, in order to bias the spool 202 to retrievingly wind the leash 106. The bias device 308 turns the spool 202 to wind the leash 106 if the spool 202 is not locked (via the leash lock button 108) and the leash 106 is not extendingly pulled from the housing 102 overcoming the recoil bias of the spool 202. The bushings 306 of the chamber 304 cylindrically surround and abut the spring within the chamber 304 to maintain the spool 202 in substantially concentric relation with the spindle 204. The housing 102 may, but need not necessarily, include and/or contain other elements, for example, one or more guide appendage 310 to retain the spool 202 relative to the housing 102, structural devices, and/or others.

Referring to FIG. 4, in conjunction with FIGS. 1-3, a disengaged leash system 400 of the half-portion of the housing 102 (taken along line A-A′ of FIG. 1, as with FIG. 2) includes the leash lock button 108 positioned along the slot 212 away from the portal 104 (i.e., downward in the view of FIG. 4). As the leash lock button 108 is so positioned (e.g., downward) along the slot 212, the clutch 214 is guided by the clutch guides 220 away from crimped engagement of the first end 214a with the leash 106. The second end 214b of the clutch 214 is also dislodged from the rib 211 and passes to space within the housing 102 removed from the spool 202.

When the clutch 214 is disengaged from locking the leash 106, the leash 106 can be extendingly pulled from the spool 202 by countering the recoil bias of the spool 202. Arrow B illustrates rotation of the spool 202 (i.e., clockwise in FIG. 4) against the recoil bias, as the leash 106 is extendingly pulled from the spool 202 exiting the portal 104. If the leash 106 is not extendingly pulled in such manner (or tied or retained, as the case may be, against the bias), the bias device 308 (not shown in detail in FIG. 4) rotates the spool 202 counter to Arrow B (i.e., counterclockwise in FIG. 4) causing any extended portion of the leash 106 to retract through the portal and wind on the spool 202. The end 106a (shown in FIG. 1) of the leash 106 may include a hook, loop, buckle, or other device, or may be knotted or otherwise bunched, to prevent the end 106a from retracting into the housing 102 through the portal 104.

Referring to FIG. 5, in conjunction with FIGS. 1-4, an engaged leash system 500 of the half-portion of the housing 102 (taken along line A-A′ of FIG. 1, as with FIG. 2) includes the leash lock button 108 positioned along the slot 212 towards the portal 104 (i.e., upward in the view of FIG. 5). As the leash lock button 108 is so positioned (e.g., upward) along the slot 212, the clutch 214 is guided by the clutch guides 220 toward and into crimped engagement of the first end 214a with the leash 106. The second end 214b of the clutch 214 moves within the housing 102 into contact with the rib 211, and the second end 214b of the clutch 214 is lodged against the rib 211 for locking the leash lock button 108 and clutch 214 in locked position. In locked position, the leash 106 is crimped against the first end 214a of the clutch 214 preventing the leash 106 from extending from or retracting on the spool 202.

When the clutch 214 is engaged for locking the leash 106, the leash 106 remains extended to the extent then pulled from the spool 202. The clutch 214 sufficiently crimps the leash 106 to counter recoil bias of the spool 202 and also to preclude further extension of the leash 106 from the spool 202. The clutch 214 may, but need not necessarily, force the leash 106, where crimped, against the spool 202, with sufficient force against the leash 106 and spool 202 to prevent extension or retraction of the leash 106. In use, the clutch 214 may be selectively disengaged and engaged to allow desired extension and tie or other anchor of the end 106a of the leash 106 to a structure, and retraction of the leash 106 to the spool 202 to avoid slack of the leash 106 once ties or anchored.

Referring to FIGS. 6A and 6B, in conjunction with FIGS. 1-5, a system 600 includes a clamp 602 connectable to a ladder rail 612. A non-exclusive example of the ladder leash system 600 includes the systems 100, 200, 300, 400, 500 of FIGS. 1-5. A non-exclusive example of the clamp 610 includes the clamp 110 of FIGS. 1-2, 4 and 5. The ladder leash system 600 includes a housing 602 containing a length of leash 606. An end 606a of the leash 606 passes through and external to the housing 602 via a portal 604 of the housing 602. A device (not shown in FIGS. 6A and 6B) connected to the housing 602 biases the leash 606 to retract to the housing 602, through the portal 604, to within the housing 602. The end 606a can be pulled, overcoming retraction bias, to extend additional portion of the leash 606 from the housing 602. A lock button 608 is connected to the housing 602. The lock button 608 is positionable for selectively clutching the leash 606 to limit extension or retraction of the leash 606. The end 606a of the leash 606 may include a knot, hook, buckle, clasp, or bundle to prevent the end 606a from retracting into the housing 602.

The clamp 610 is connected to, formed by, or incorporated with the housing 602. In certain non-exclusive examples, the clamp 610 is removably or fixedly attached to the housing 602 by one or more screw, rivet, pin and socket, or other similar or combination of attachments. The clamp 604 is connectable to the ladder 613, for example, a side rail (as shown in FIGS. 6A and 6B), rung or other structure of a rigid, extension, fixed, folding, telescoping, or other ladder or similar fixture. The clamp 604 rigidly connects to the ladder 613 in use of the system 600, however, the clamp 604 may be unclamped and removed from the ladder 613, such as to switch to a different ladder or implement.

The clamp 610 includes a bracket 612 connected to the housing 602, as described. The bracket 612 includes a length abutting the housing 602 where connected thereto, a bend (for example, an about 90° bend), a lateral extension (for example, extending from connection to the housing 602), and a lip at extent of the lateral extension. The lateral extension includes a mediate hole (not shown in detail in FIGS. 6A and 6B), through which a screw 616 of a lock lever 614 resides. The lock lever 614 is positioned along the lateral extension of the bracket 612, for example, atop the bracket 612 (in FIGS. 6 and 7), to allow access to the lock lever 614 when the clamp 610 is placed on the ladder 613. The lock lever 614 includes a pivoting arm and a rotating base. A gripper 618 of the clamp 610 includes a body with a screw hole (not shown in detail) for accepting the screw 616 passed through the mediate hole of the bracket 612, for example, under the bracket 612 (in FIGS. 6 and 7). The body of the gripper 618 extends in a generally U-shape (in FIGS. 6 and 7) to provide a hold portion 618a for, in use, contacting the ladder 613 for clamping.

When the lock lever 614 is rotated on the base, as shown by Arrow C, the screw 616 travels in threads of the screw hole of the gripper 618 to tighten the hold portion 618a of the gripper 618 towards the bracket 612. The hold portion 618 can, but need not necessarily, include a bumper 620 that corresponds to an opposing pad 622 of the bracket 612. A portion of the ladder 613 (or other implement, as the case may be) located between the bumper 620 and the opposing pad 622 is retained by the rotating the lock lever 614 in the direction of Arrow C until tightened. The portion of the ladder 613 is further retained from lateral movement (in FIGS. 6 and 7) by the lip of the bracket 612. The pivoting arm of the lock lever 614 pivots on a pin 624 of the base of the lock lever 614. After the lock lever 614 is rotated to retain the ladder 613 between the hold portion 618a and the bracket 612, the pivoting arm of the lock lever 614 is depressed, as shown by Arrow D, to increase clamping pressure against the ladder 613 between the hold portion 618a of the gripper 618 and the underside of the bracket 612.

If removal of the system 600 from the ladder 613 is desired, the pivoting arm of the lock lever 714 is pulled pivoting on the pin 624 in reverse of Arrow D. The lock lever 614 is then rotated on its base in reverse of Arrow C, to further separate the hold portion 618a from the bracket 612 sufficient to allow release of the ladder 613. The clamp 610 is adaptable to various sizes and shapes because of the lock lever 614 and its dual action of rotation and depression. The rotatability of the lock lever 714 allows varying separation of the hold portion 618a from the bracket 612, in order to provide wider or narrower opening between the hold portion 618a and the bracket 612 and to retain ladders and other implements having wide variety of shapes and sizes. The levering action of the pivoting arm of the lock lever 714 provides secure grip and retention of the clamp to ladders and other implements with which the system 600 is employed.

In operation, the lock lever 614 is rotated (e.g., counterclockwise) on its base with respect to the bracket 612, to expand separation between the hold portion 618a of the gripper 618 and the underside of the bracket 612 sufficient to accommodate a ladder or implement. In the case of a ladder, a facing portion of a side rail of the ladder (for example, an outer side of a side rail) is positioned between with a side against the lip of the bracket 612 and facing portion against the against the bracket 612. The hold portion 618a of the gripper 618 is positioned to catch an underside of the facing portion of the ladder. The pivoting arm of the lock lever 614 is then rotated (e.g., counterclockwise) on its base with respect to the bracket 612, causing the hold portion 618a to snug against the underside of the facing portion of the ladder and retain the facing portion snugly between the hold portion 618a and the bracket 612. The pivoting arm of the lock lever 614 is then depressed (as in Arrow D) to securely clamp the system 600 to the ladder.

Once the system 600 is clamped to the ladder or implement, the ladder or implement is placed for use, for example, the ladder is situated leaning against a building and climbed. At the raised location, for example, a roof, the lock button 608 is positioned to release the clutch of the leash 606 by the system 600. The leash 606 is pulled with sufficient force to overcome the retraction bias and extended from within the housing 602 of desired length to tie or otherwise attach the leash 606 near the end 606a to a fixture of the raised location, for example, an exhaust pipe, gutter, or other structure. Once the leash 606 is attached to the fixture, the lock button 608 is positioned for clutching the leash 606 to limit extension or retraction of the leash 606. The leash 606 maintains the ladder or other implement from significantly shifting, falling or otherwise becoming displaced in position.

If the ladder or implement is next to be moved, such as to a different location of the building or structure, the leash 606 is untied or otherwise detached from the fixture at the raised location. The lock button 608 is positioned to release the clutch of the leash 606, and the retraction bias of the system 600 recalls the extended portion of the leash 606 to the housing 602. The process can then be repeated for each move of the ladder or implement. The ladder or implement can be stored with or without the system 600 clamped to the ladder, and the leash 606 can be retracted to the housing 602 to avoid entanglement. As previously described, the system 600 can be unclamped from a particular ladder or implement, and moved and clamped to another ladder or implement as desired.

Referring to FIGS. 7 and 8, certain embodiments of a leash system 700 in FIGS. 7 and 800 in FIG. 8, for example, those of FIGS. 1-6B, can be clamped to either outside rail of a ladder, for example, a right side rail 702 of FIG. 7 and/or left side rail 802 of FIG. 8. In these embodiments, one or more connector 706 is formed in or incorporated with opposing sides of the housing 704 of the leash system. A bracket 708, for example, such as the bracket 612 of the clamp 610 of FIGS. 6A and B, includes one or more mating connector 808 corresponding to the one or more connector 706 of the housing 704. The bracket 708 can be connected to a first side 704a of the housing 704, to allow the bracket 708 to be attached to the right side rail 702 (in FIG. 7) or to be attached to the left side rail 802 (in FIG. 8). Further, more than one, for example, two or any number, of the leash system 700, 800 can be simultaneously employed on a ladder or other implement, for example, one leash system 700 attached to the right side rail 702 and another leash system 800 attached to the left side rail 802, if desired.

Continuing to refer to FIG. 9, in conjunction with FIGS. 7 and 8, a bracket 708 (shown in FIGS. 7 and 8) of a leash system 700,800 may connect to the housing 704 in angled relationship to the extension direction of the leash 606. In the case of use of the leash system 700, 800 with a ladder 902, bracket 708 when in use for clamping to a side rail of the 902 ladder may be angled to allow a generally horizontal extension direction of the leash 606 when the ladder 902 is raised at an about 75° angle from horizontal (e.g., as may be the case when the ladder is employed against a building or other structure). Other angular relationships are possible by varying placement of connectors or other attachments connecting or fixing the bracket 708 to the housing 704, or as otherwise desired for particular application or use.

Referring to FIGS. 10A-C, in conjunction with FIGS. 1-9, a ladder leash system 1000 is clamped to ladders 1002, 1004, 1006, respectively, of varied side rail configuration. The ladder leash system 1000 includes a clamp 1010 connected to a housing 1012 containing a retracting leash 1014, according to certain embodiments of FIGS. 1-2 and 4-8. A bracket 1016 and gripper 1018 of the clamp 1010 is suitably sized and configured to accommodate and clamp, for example, an aluminum extension ladder 1002 of FIG. 10A, a fiberglass or composite ladder 1004 of FIG. 10B, a steel ladder 1006 of FIG. 10C, or other similar ladder or implement having similar shape of such ladders in a region suitable for clamping.

Referring to FIG. 11, an alternative leash system 1100 includes a housing 1102 retractably containing a leash 1106. A lock button 1108 connected to the housing 1102 controls a clutch (not shown in FIG. 11) internal to the housing 1102. The lock button 1108 is positionable to selectively invoke clutching of the leash 1106 and halt clutching. A bracket 1110 and clamp 1112 is connected to the housing 1102 at an end opposing extension direction of the leash 1106. The clamp 1112 is, for example, a toggle clamp.

Referring to FIG. 12, in conjunction with FIG. 11, the clamp 1112, when toggled by raising of a clamp lever 1112b, retains the system 1100 to a ladder 1114, such as a fixed ladder, or other implement or device, located at least in part, between a toggle 1112a and the bracket 1110. The clamp 1112 is relieved from clamping the ladder 1114 (or other device) by depression of the clamp lever 1112b (towards the bracket 1110 in FIG. 12).

In the foregoing embodiments, a variety of materials and manufacturing techniques and processes may be employed. Non-exclusive examples of leash materials include nylon cord (“accessory cord”), vinyl-coated wire rope, cotton rope or cord, leather strap, and others, and the leash may be of varied strength and diameter/size. A 3 mm accessory cord, for example, provides suitable windability and break strength, although other rope, cord, or the like may be employed. Non-exclusive examples of spool materials include nylon, plastic, steel, metal, and others. Non-exclusive examples of housing materials include plastic, nylon, fiberglass, metal, and others. Plastic extruded or moulded materials are suitable, however, other materials are possible in embodiments. Clutch materials may formed of plastic, nylon, metal or others, as desired in the application. Bracket and clamp materials can include metal, strong plastic, nylon, stainless steel, and others, although these are merely non-exclusive examples and other materials may be desirable in particular applications. The bracket and clamp can each be moulded, bent, extruded, or otherwise manufactured, in whole or part. Although sizing of the leash system may be as desired for the particular application, leash systems for use with ladders may be desirably be sized to be unobtrusive and to not interfere with ladder use during climbing. For example, profile of the system when attached to a ladder may be such that the system is substantially consistent in size with size of ladder side rails or otherwise.

Although certain specific embodiments have been described, numerous variations are possible. A leash system may include a knob and screw system for clutching the leash. Various alternative clamping and attachment devices may be employed for either permanently or removably fixing the systems to ladders, implements and other devices, all as desired for particular application and use. Clamps may be varied in design, configuration and operation as may be desired, including for attachment to various equipment, implements and the like, in addition to or in lieu of ladders. Spool biasing, as well as spool configurations, may be varied as may be suitable or operable in any particular situation and use. Biasing of the spool may be by spring or any other suitable mechanism, and biasing may include mechanized, motorized, or other elements as may be desired. Any suitable clutch for the leash and/or spool is possible, including as non-exclusive examples, brake devices, pads, screws, stops, and others. Housing of the system can be varied in design, style, shape, and type, and can form enclosures, partial enclosures, or no enclosure, as may be suitable. There need not be any housing, if open spool or leash collection elements are desired.

As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent. Certain embodiments of the present invention have been described in the specification and figures, and these are to be regarded in an illustrative rather than restrictive sense. Any benefits, advantages, or solutions to problems that may have been described with regard to specific embodiments, as well as devices, connections, steps, features or elements that may cause or provide any benefit, advantage, or solution to occur or become more pronounced, are not to be construed as critical, required, or essential. Those of ordinary skill in the art will appreciate that various modifications, substitutions, deletions, additions, and other changes can be made in embodiments without departing from the scope of the present invention set forth in the claims.

What is claimed is:

1. A system, comprising:
a spool;
a leash wrapping the spool, a first end of the leash is connected to the spool and a second end of the leash is unwrappingly extendable from the spool;
a bias device connected to the spool for biasing the spool to wrappingly retrieve the leash when extended;
a housing connected to and containing the spool, the housing includes a portal, the second end of the leash exiting the housing through the portal; and
a clamp connected to the housing.

2. The system of claim 1, further comprising:
a clutch connected to the housing, the clutch selectively engageable to lock the leash extended from the spool.

3. The system of claim 2, further comprising:
a button connected to the housing, the button positionable to selectively engage and disengage the clutch.

4. The system of claim 2, wherein the bias device is overcome and the leash extended from the spool by manual pull on the second end of the leash when the clutch is disengaged.

5. The system of claim 2, wherein the bias device is a spring connected to the spool.

6. The system of claim 3, wherein the clutch is formed as an extension of the button.

7. The system of claim 6, wherein the clutch crimps the leash within the housing to prevent extension or retraction of the leash, when the clutch is engaged by selectively positioning the button for engaging the clutch.

8. A system for retaining a ladder to a structure, comprising:
a clamp;
a spool connected to the clamp;
a leash wrapping the spool, the leash has a first end connected to the spool and a second end extendable from the spool;
a spring connected to the spool for biasing the spool to retrieve the leash when extended from the spool; and
a lease clutch connected to the clamp, for limiting extension and retraction of the the leash on the spool.

9. The system of claim 8, further comprising:
a housing connected to the clamp and enclosing the spool, the housing includes a portal, the second end of the leash is extendable from the spool through portal.

10. The system of claim 9, further comprising:
a switch at least in part external to the housing, connected to the lease clutch, for selectively engaging and disengaging the lease clutch.

11. The system of claim 8, wherein the clamp includes a first clamp surface and a second clamp surface for clamping, a vise screw of the clamp selectively varies space between the first clamp surface and the second clamp surface and a clamp toggle narrows space between the first clamp surface and the second clamp surface for clamping.

12. The system of claim 10, wherein the leash clutch prevents extension or retraction of the leash when the leash clutch is engaged by selectively positioning the switch.

13. The system of claim 8, wherein the leash is extendable by pull on the second end of the leash sufficient to overcome biasing of spool by the spring.

14. The system of claim 8, further comprising:
a fastener connected to the second end of the leash.

15. The system of claim 11, wherein the first clamp surface and the second clamp surface secure the clamp to at least a portion of a side rail of the ladder.

16. The system of claim 15, wherein the clamp is removeable from the ladder and the system is reusable.

17. A system for retaining a ladder to a structure, comprising:
a leash, having a first end and a second end;
a biased spool containing the leash, the first end of the leash connected to the biased spool and the second end of the leash extendable from the biased spool by pulling the second end sufficient to overcome biasing of the biased spool; and
a clamp connected to the biased spool, the clamp removably attachable to the ladder.

18. The system of claim 17, further comprising:
a housing containing the biased spool, the housing includes a portal, the second end of the leash passes through the portal to exit the housing.

19. The system of claim 17, wherein the clamp is adapted for removable attachment to a variety of ladders.

20. A method of retaining a ladder to a structure, comprising the steps of:
attaching a retractable leash to the ladder; and
selectively clutching the retractable leash to prevent the retractable leash from retracting and extending.
